(19) United States
(12) Patent Application Publication
(10) Pub. No.: US 2021/0114626 A1
(43) Pub. Date: Apr. 22, 2021

(54) VEHICLE CONTROL SYSTEM, VEHICLE CONTROL DEVICE, AND VEHICLE CONTROL METHOD

(71) Applicant: HONDA MOTOR CO., LTD., Minato-ku, Tokyo (JP)

(72) Inventors: Takafumi Hirose, Wako-shi (JP); Naoto Yasuda, Wako-shi (JP); Yuki Oshitani, Tokyo (JP); Susumu Iwamoto, Tokyo (JP)

(21) Appl. No.: 16/970,406

(22) PCT Filed: Oct. 16, 2018
(86) PCT No.: PCT/JP2018/038498

§ 371 Date: Aug. 17, 2020

(30) Foreign Application Priority Data
Feb. 22, 2018 (JP) 2018-029858

(51) Int. Cl. B60W 60/00; B60W 40/08

(52) U.S. Cl. CPC B60W 60/0025; B60W 2556/45; B60W 40/08

(57) ABSTRACT

A vehicle control system includes a service management device that is configured to estimate an out-of-use period in which a user does not use an automated driving vehicle on the basis of reference information including a usage schedule of the automated driving vehicle by the user, and that is configured to manage a predetermined service provided in a state in which the user does not use the automated driving vehicle in the estimated out-of-use period, and a controller configured to generate an action plan of the automated driving vehicle in the out-of-use period according to the predetermined service managed by the service management device.

### TECHNICAL FIELD

The present invention relates to a vehicle control system, a vehicle control device, and a vehicle control method.

Priority is claimed on Japanese Patent Application No. 2018-29858, filed Feb. 22, 2018, the content of which is incorporated herein by reference.

### BACKGROUND ART

In a general navigation device for a vehicle, guidance is terminated when a vehicle arrives at a set destination, and set retrieval conditions are released. In connection with this, a technology of saving a retrieval result even when the vehicle has arrived at a destination, estimating a staying time according to the destination, and providing the saved retrieval result to a user when a time until an engine of the vehicle is turned on is shorter than the estimated staying time is known (for example, see Patent Literature 1).

### CITATION LIST

### Patent Literature

### [Patent Literature 1]

Japanese Unexamined Patent Application, First Publication No. 2007-322282

### SUMMARY OF INVENTION

### Technical Problem

However, this conventional system only estimates a staying time in order to reuse the retrieval result, and it has not been considered that the staying time may be estimated to promote the usage of the vehicle after an occupant has alighted.

In consideration of the above-mentioned circumstances, the present invention is directed to providing a vehicle control system, a vehicle control device, and a vehicle control method that are capable of promoting usage of an automated driving vehicle during a period in which a user does not use the automated driving vehicle.

### Solution to Problem

A vehicle control system, a vehicle control device, and a vehicle control method according to the present invention employ the following configurations.

(1) An aspect of the present invention is a vehicle control system including a service management device that is configured to estimate an out-of-use period in which a user does not use an automated driving vehicle on the basis of reference information including a usage schedule of the automated driving vehicle of the user, and that is configured to manage a predetermined service provided in a state in which the user is not using the automated driving vehicle in the estimated out-of-use period; and a controller configured to generate an action plan of the automated driving vehicle in the out-of-use period according to the predetermined service managed by the service management device.

(2) In the aspect of the above-mentioned (1), the service management device estimates an action after the user alights from the automated driving vehicle, and includes the estimated action in the reference information.

(3) In the aspect of the above-mentioned (1), the service management device estimates an action pattern of the user, and includes the estimated action pattern of the user in the reference information.

(4) In the aspect of the above-mentioned (1), the service management device corrects the out-of-use period on the basis of a status of the user.

(5) In the aspect of the above-mentioned (1), the service management device acquires information related to a person who relates to a schedule of the user, and includes the acquired information related to the person who relates to the schedule of the user in the reference information.

(6) In the aspect of the above-mentioned (1), the service management device requires the user to agree that the predetermined service will be provided in the out-of-use period, and performs processing to start the predetermined service when approved by the user.

(7) In the aspect of the above-mentioned (1), the service management device estimates a plurality of out-of-use period candidates having different lengths, and performs processing to provide the predetermined service that is providable in the respective out-of-use period candidates to the user among some or all of the estimated out-of-use period candidates.

(8) An aspect of the present invention is a vehicle control device including: an acquisition part configured to estimate an out-of-use period in which a user does not use an automated driving vehicle on the basis of reference information including a usage schedule of the automated driving vehicle by the user, and acquire information related to a predetermined service provided in a state in which the user does not use the automated driving vehicle in the estimated out-of-use period; and a controller configured to generate an action plan of the automated driving vehicle in the out-of-use period on the basis of the information acquired by the acquisition part.

(9) An aspect of the present invention is a vehicle control method executed by one or more computers, the method including: estimating an out-of-use period in which a user does not use an automated driving vehicle on the basis of reference information including a usage schedule of the automated driving vehicle by the user, and managing a predetermined service provided in a state in which the user does not use the automated driving vehicle in the estimated out-of-use period; and generating an action plan of the automated driving vehicle in the out-of-use period according to the predetermined service.

### Advantageous Effects of Invention

According to the above-mentioned aspects (1) to (9), it is possible to promote usage of an automated driving vehicle during a period in which a user does not use the automated driving vehicle.

### BRIEF DESCRIPTION OF DRAWINGS

FIG. 1 is a configuration view of a vehicle control system 1 according to an embodiment.

FIG. 2 is a configuration view of a service management device 500.

FIG. 3 is a view showing an example of contents of schedule information 531.

FIG. 4 is a view showing an example of contents of service conditions information 532.

FIG. 5 is a view showing an example of contents of location information 533.

FIG. 6 is a view showing an example of contents of vehicle status information 534.

FIG. 7 is a view showing an example of contents of usage history information 535.

FIG. 8 is a configuration view of a vehicle control device 5 according to an embodiment.

FIG. 9 is a functional configuration view of a first controller 120 and a second controller 160.

FIG. 10 is a sequence diagram showing an example of a flow of a series of processing by the vehicle control system 1 of the embodiment.

FIG. 11 is a flowchart showing an example of a flow of schedule supplement processing.

FIG. 12 is a flowchart showing an example of a flow of out-of-use period estimation processing.

FIG. 13 is a flowchart showing an example of a flow of service determination processing.

FIG. 14 is a flowchart showing another example of the flow of the service determination processing.

FIG. 15 is a flowchart showing an example of a flow of reviewing processing.

FIG. 16 is a view showing an example of a hardware configuration of an automated driving control device 100 of an embodiment.

### DESCRIPTION OF EMBODIMENTS

Hereinafter, embodiments of a vehicle control system, a vehicle control device, and a vehicle control method of the present invention will be described with reference to the accompanying drawings.

### [Entire Configuration]

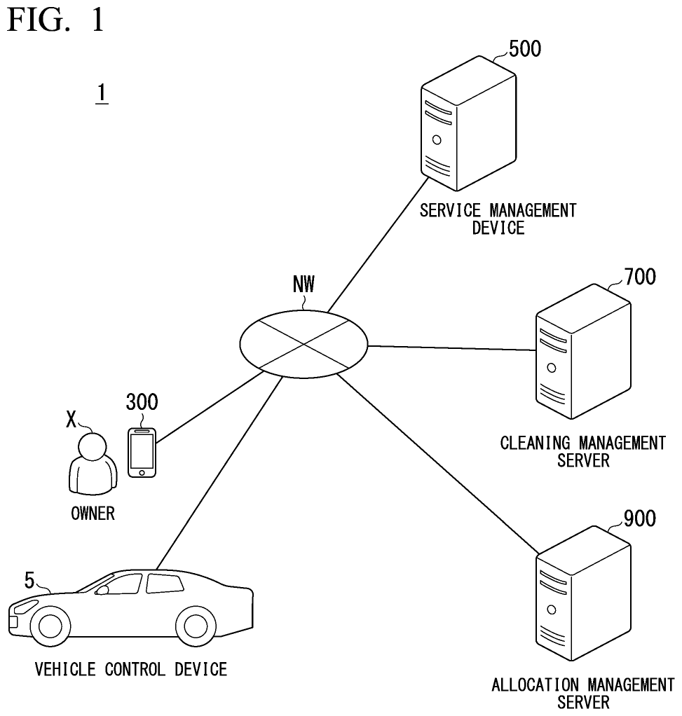

FIG. 1 is a configuration view of a vehicle control system 1 according to an embodiment. The vehicle control system 1 is realized by one or more processors (computers). The vehicle control system 1 includes, for example, one or more vehicle control devices 5, one or more terminal devices 300, a service management device 500, a cleaning management server 700 and an allocation management server 900. The vehicle control device 5 is vehicle onboard devices mounted on an automated driving vehicle having an automated driving function. The automated driving vehicle is, for example, a private vehicle of an owner X. The terminal device 300 is a terminal device owned by the owner X, and a portable terminal device having at least a communication function and an information input/out function, for example, a cellular phone such as a smart phone, a tablet terminal, a laptop computer, a personal digital assistant (PDA), or the like.

The service management device 500 manages a service provided in a state in which the owner X does not use an automated driving vehicle (hereinafter, referred to as a second service). In the second service, the automated driving vehicle is moved to a place according to the second service or travels along a path according to the second service. The second service includes, for example, a cleaning service, a car sharing service, a taxi service, a charging service, a delivery service, a delivery locker service, and the like. For example, the cleaning service is a service of causing the automated driving vehicle of the owner X to travel to a cleaning facility, and causing the automated driving vehicle to travel a designated place after completion of a cleaning work or the like in the cleaning facility (cleaning of a vehicle body, cleaning of the inside of the vehicle, change of disposition of seat sheets, checking, other maintenances, and the like). For example, the car sharing service is a service in which the automated driving vehicle of the owner X is utilized as a vehicle used by other users other than the owner X (hereinafter, referred to as a shared car). For example, the taxi service is a service in which the automated driving vehicle of the owner X is utilized as a taxi. For example, the charging service is a service of causing the automated driving vehicle of the owner X to travel to a charging facility or a gas station to charge a battery of an electric vehicle, and causing the automated driving vehicle to travel to a designated place after charging by a charging facility or a gas station, or reception of supply of gasoline. The delivery service is a service in which delivery goods are placed on the automated driving vehicle and transported to a delivery destination in cooperation with a delivery company. The delivery locker service is a service in which the automated driving vehicle is utilized as a delivery locker, and for example, a service in which the automated driving vehicle takes delivery goods to a user who arrives within a predetermined time to a cargo collection center of a delivery company and stores them in the automated driving vehicle as they are, and a user who is the delivery destination of the delivery goods comes to the automated driving vehicle and delivers them.

The service management device 500 comes in communication with the cleaning management server 700 and acquires predetermined information when processing of providing a cleaning service is performed. In addition, the service management device 500 comes in communication with the allocation management server 900 and acquires predetermined information when processing of providing a car sharing service or a taxi service is performed. The service management device 500 may come in communication with other external servers and acquire information required to provide the second service (for example, information related to a usage status of a charging facility or equipment of a gas station, or the like).

The cleaning management server 700 is a server operated by a business operator such as a cleaning company or the like, and receives information related to a cleaning request from a guest and provides various services related to cleaning of the vehicle. The cleaning management server 700 selects a cleaning facility according to a cleaning request from a plurality of cleaning facilities when presentation of the cleaning facilities is instructed by the service management device 500, and transmits information related to the selected cleaning facility to the service management device 500. Services that can be provided by the cleaning facilities often differ depending on equipment and personnel of the facilities.

The allocation management server 900 is a server operated by a business operator such as a taxi company, a car sharing company, or the like, and receives information related to an allocation request or the like from a guest and provides various services related to the allocation. The allocation management server 900 instructs the allocation of the automated driving vehicle according to the allocation request from the guest to the service management device 500. For example, the allocation management server 900 transmits the information related to the allocation request from the guest (for example, a call place, a waiting time, a reservation number of people, a destination, or the like) to the service management device 500, and instructs the allocation. The call place is a place where a shared car or a taxi picks up a guest. In addition, the allocation management server 900 may transmit information indicating an area that is likely to pick up a guest when traveling as a cruising taxi without customer on board or an area where shared cars or taxis are not enough to the service management device 500.

The vehicle control device 5, the terminal device 300, the service management device 500, the cleaning management server 700 and the allocation management server 900 are connected to each other by a network NW, and come in communication with each other via the network NW. The network NW includes, for example, some or all of a wide area network (WAN), a local area network (LAN), the Internet, a dedicated line, a radio base station, a provider, and the like.

Here, an example of a usage scene of the vehicle control system 1 according to the embodiment will be described. For example, it is assumed that the owner X leaves the home by boarding in the automated driving vehicle and arrives at a shopping mall that is a destination in the morning. The owner X has a schedule that stays in the shopping mall until evening. In such a scene, the owner X can receive the second service during the out-of-use period from arrival to the shopping mall to the return. The service management device 500 estimates the out-of-use period and performs various types of processing to provide the second service according to the estimated out-of-use period. For example, the service management device 500 estimates the out-of-use period from 10 a.m. to 5 p.m., and estimates the return point as the shopping mall. The vehicle control device 5 and the service management device 500 cause the automated driving vehicle to travel so that the vehicle can return to the shopping mall by 5 p.m. Further, the usage scene of the second service is not limited thereto, and it can be used as a taxi during the out-of-use period when the automated driving vehicle is not used by the owner X, for example, during the day of weekdays or at night on Saturdays and Sundays. In this case, the return point is the home or the like of the owner X.

### [Service Management Device 500]

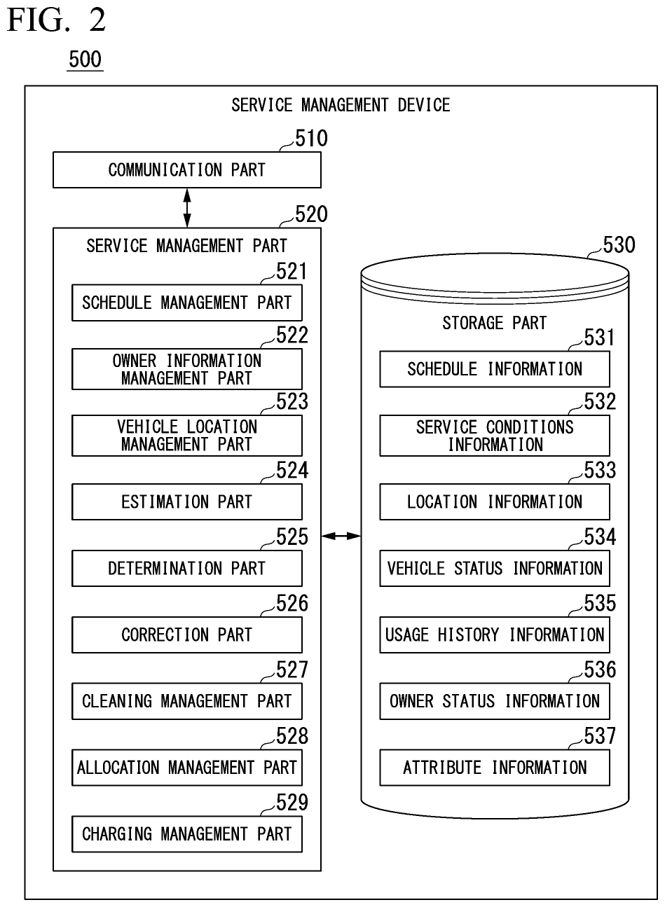

First, the service management device 500 will be described. FIG. 2 is a configuration view of the service management device 500. The service management device 500 includes a communication part 510, a service management part 520 and a storage part 530. The communication part 510 includes a communication interface such as an NIC or the like. The storage part 530 is a flash memory such as a random access memory (RAM), a read only memory (ROM), a solid state drive (SSD), or the like, a hard disk drive (HDD), or the like. The storage part 530 stores information, for example, schedule information 531, service conditions information 532, location information 533, vehicle status information 534, usage history information 535, owner status information 536, attribute information 537, and the like. The storage part 530 may be an external storage device such as a network attached storage (NAS) to which the service management device 500 is accessible via a network. The service management part 520 executes various types of processing described below using the information stored in the storage part 530.

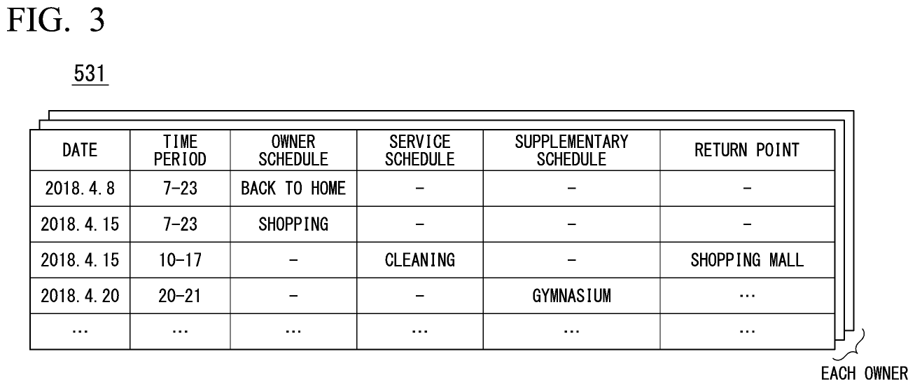

The schedule information 531 is information related to the usage schedule of the automated driving vehicle. FIG. 3 is a view showing an example of details of the schedule information 531. The schedule information 531 may include not only the schedule of each owner X but also information related to a user's schedule having a relationship with the owner X.

As shown in FIG. 3, the schedule information 531 is information in which a time period, an owner schedule, a service schedule, a supplementary schedule and a return point are associated with dates. A table shown in FIG. 3 is prepared for each owner (including a related user). The date and the time period are a date and a time to which each schedule is set. The owner schedule is an individual schedule of the owner X, which is registered by the owner X. The owner schedule includes, for example, information related to the usage schedule of the automated driving vehicle of the owner X (for example, a destination, an intended purpose, or the like). The service schedule includes information related to the usage schedule of the second service (for example, a type of the second service, a usage facility name, or the like). Further, in the service schedule, “∘” indicating that some kind of a second service schedule is set or “−” indicating that no second service schedule is set may be entered. The usage schedule may be set by the owner X, or may be set by the service management device 500 on the basis of the usage schedule set by the owner X, the service conditions information 532, or the like. The supplementary schedule is a supplementary schedule determined by a schedule management part 521, which will be described below. The return point is a point to which the automated driving vehicle returns after the second service is terminated, and for example, is a point at which the owner X desires to join the automated driving vehicle.

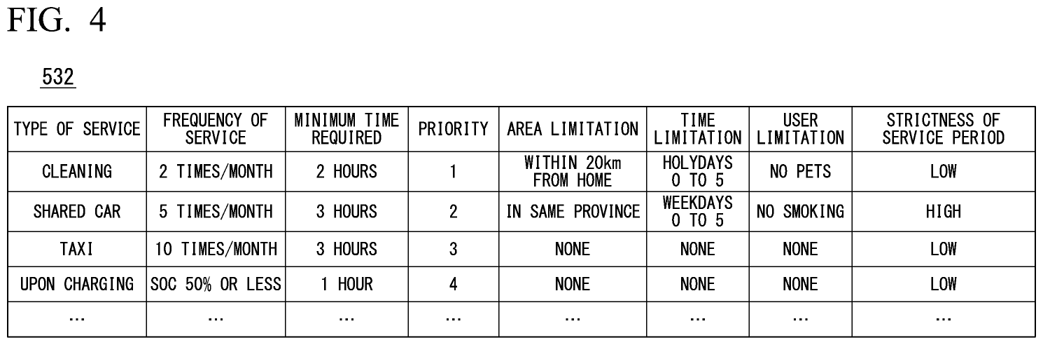

The service conditions information 532 is information indicating a service condition set by the owner X. FIG. 4 is a view showing an example of details of the service conditions information 532. As shown in FIG. 4, the service conditions information 532 is information in which a frequency of a service, a minimum time required, a priority, an area limitation, a time limitation, a user limitation, strictness of a service period, and the like, are associated with types of services. The service conditions information 532 is information indicating conditions desired by the owner X when the second service is received. The type of service is information indicating a type of second service, and for example, a name of the second service. The frequency of the service is a usage frequency of each second service desired by the owner X. The minimum time required is a lower limit of a time length of each second service desired by the owner X. For example, it is possible to distinguish between an owner who desires to make the automated driving vehicle travel as a taxi even if there are only 30 minutes and an owner who does not desire to make the automated driving vehicle travel as a taxi if it is not at least about two hours. The priority is a priority given when the second service provided by the service management device 500 is determined. The area limitation indicates an area in which the automated driving vehicle can travel during provision of the second service. The time limitation indicates a time period in which the automated driving vehicle can travel during provision of the second service. The user limitation indicates a limit of a guest who is allowed to ride in the automated driving vehicle. The strictness of the service period is information indicating whether the owner X allows a service to be provided outside of the service period. When the strictness of the service period is high, the service is limited to that which can be provided within the service period, and when the strictness of the service period is low, a service that can be provided during the period outside the service period is also allowed.

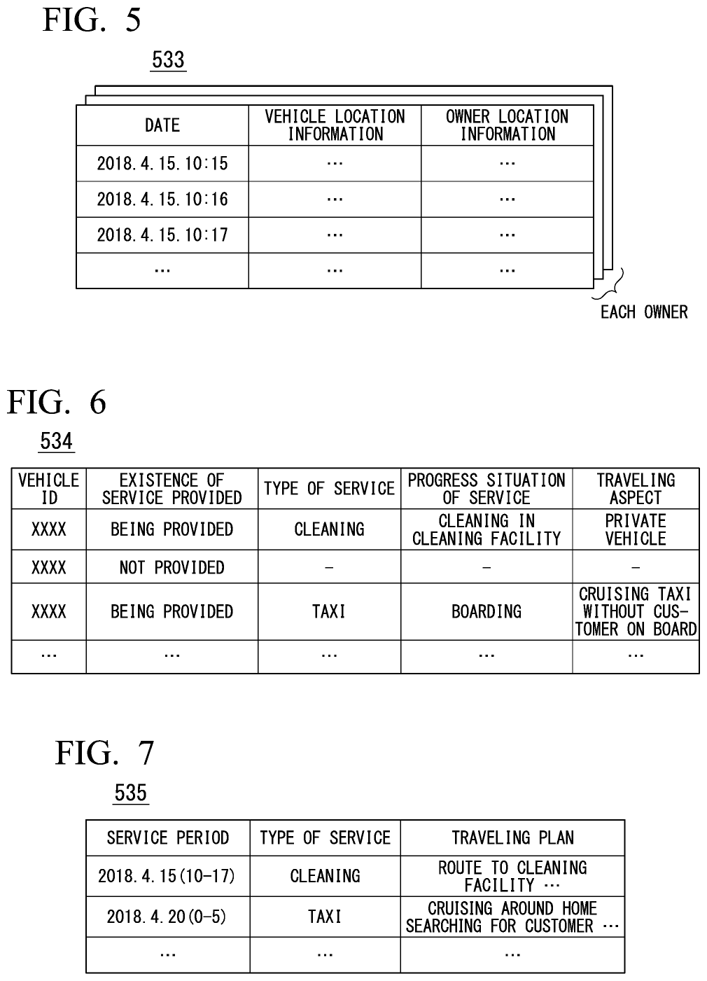

The location information 533 is information designating a position of the automated driving vehicle. FIG. 5 is a view showing an example of details of the location information 533. As shown in FIG. 5, the location information 533 is information in which the vehicle location information and the owner location information are associated with the date and the time. The vehicle location information is information indicating a location of the automated driving vehicle acquired by a navigation device 50. The owner location information is information indicating a location of the terminal device 300 acquired by a global navigation satellite system (GNSS) or the like of the terminal device 300 owned by the owner X.

The vehicle status information 534 is information indicating a state of each automated driving vehicle. FIG. 6 is a view showing an example of details of the vehicle status information 534. As shown in FIG. 6, the vehicle status information 534 is information in which existence of service provision, a type of service, a progress state of the service, a traveling aspect, a return point, a traveling aspect, and the like, are associated with a vehicle ID. The vehicle ID is identification information that identifies each automated driving vehicle. The existence of service provision is information indicating whether the service is being provided. The progress state of the service is information indicating a progress level of the service being provided, details of the service being provided, or the like. The traveling aspect is a traveling aspect of the automated driving vehicle, which includes, for example, a cruising taxi without customer on board, a call taxi, a private vehicle, or the like. The traveling aspect will be described below in detail.

The usage history information 535 is history information of the second service provided to each owner X. FIG. 7 is a view showing an example of details of the usage history information 535. As shown in FIG. 7, the usage history information 535 is information in which a type of service, a first action plan, and the like, are associated with a service period. The service period and the first action plan will be described below.

The owner status information 536 includes, for example, card usage information, contribution information, store usage information, information indicating an estimated status of the owner, and the like. The card usage information is information in which a card (a credit card, a cash card, points) is used by the owner X, and for example, includes a date and time, a place, a store name, a target commodity, and the like, with which the card is used. Further, the card usage information is not limited to usage of the card itself, and also includes information related to the processing corresponding to a pseudo usage of the card on the Web. The contribution information is information contributed on the Web using the terminal device 300, and for example, includes image data, text data, audio data, and the like. The store usage information is information or the like indicating entry or exit of the owner X. The information indicating the estimated status of the owner is information including, for example, an out-of-use period, an action of the owner X, a return point, and the like, and estimated by an estimation part 524, which will be described below.

The attribute information 537 is information indicating attributes of the owner X, and for example, includes an occupation, an age, a gender, a family structure, and the like.

Returning to FIG. 2, the service management part 520 includes, for example, the schedule management part 521, an owner information management part 522, a vehicle location management part 523, the estimation part 524, a determination part 525, a correction part 526, a cleaning management part 527, an allocation management part 528 and a charging management part 529. Some or all of these components are realized by a processor such as a central processing unit (CPU) executing a program (software) stored in the storage part 530. In addition, some or all of the functions of these components may be realized by hardware (a circuit part; including a circuitry) such as a large scale integration (LSI), an application specific integrated circuit (ASIC), a field-programmable gate array (FPGA), a graphics processing unit (GPU), and the like, or may be realized by cooperation of software and hardware.

The schedule management part 521 updates the schedule information 531 on the basis of the information received from the vehicle control device 5 or the terminal device 300 using the communication part 510. In addition, the schedule management part 521 may create a usage schedule of the automated driving vehicle with reference to the schedule information 531 and the service conditions information 532, and may add the created usage schedule to the schedule information 531. For example, the schedule management part 521 creates a service schedule in a set time period (for example, a period from 0 a.m. to 5 p.m. of a weekday) on the basis of a time limitation of the service conditions information 532.

In addition, the schedule management part 521 may create a supplementary schedule with reference to the schedule information 531, and update the schedule information 531 on the basis of the created supplementary schedule. For example, the schedule management part 521 may estimate an action pattern on the basis of the schedule of the owner X, and creates a supplementary schedule on the basis of the estimated action pattern. When an action of attending a gymnasium after 8 p.m. on Monday and Thursday of every week is estimated as the action pattern, the schedule management part 521 creates a schedule of going to a gymnasium as a supplementary schedule when there is no schedule of the gymnasium after 8 o'clock on Monday and Thursday in the individual schedule of the schedule information 531 and when there is no other schedule is planned. In this way, the schedule management part 521 creates a schedule (hereinafter, referred to as a registration missed schedule) which has a possibility that the owner X has missed to input, and sets the schedule as the supplementary schedule. Accordingly, the schedule of the owner X can be supplemented, and time and labor of registration of such schedule can be saved.

Further, there is no limitation thereto, and the schedule management part 521 may create a registration missed schedule with reference to another schedule information of the owner X existing on the Web or schedule information of other people (for example, a family) For example, when the schedule of eating with the owner X is registered in the family schedule, the schedule management part 521 creates a meal schedule as a supplementary schedule of the owner X.

In addition, the schedule management part 521 may create a schedule recommended for the owner X (hereinafter, referred to as a recommended schedule) with reference to the storage part 530, and set the recommendation schedule as a supplementary schedule. The recommendation schedule includes, for example, a schedule according to the attributes of the owner X, and a schedule in which a privilege may be given to the owner X (for example, a schedule in which four points have been earned in the past, a privilege is given when one additional point is earned, and the remaining one point is planned to be earned).

The owner information management part 522 updates the service conditions information 532 on the basis of the information received from the terminal device 300 using the communication part 510. In addition, the owner information management part 522 updates the owner status information 536 on the basis of information received from an external server using the communication part 510.

The vehicle location management part 523 updates the location information 533 on the basis of the location information received from the vehicle control device 5 using the communication part 510. In addition, the vehicle location management part 523 may also update the location information 533 on the basis of the location information received from the terminal device 300 using the communication part 510.

The estimation part 524 estimates the out-of-use period in which the owner X does not use the automated driving vehicle on the basis of the predetermined reference information. The reference information may be information stored in the storage part 530, or may be information created by the estimation part 524 on the basis of the information stored in the storage part 530. For example, the estimation part 524 may estimate the out-of-use period on the basis of some or all of information that can be referred to within a target period in which the out-of-use period is estimated among a plurality of pieces of reference information, and may estimate the out-of-use period on the basis of information having high accuracy among all the information that can be referenced. In addition, the estimation part 524 may estimate a plurality of out-of-use periods within a target period.

In addition, the estimation part 524 estimates the action of the owner X or the return point on the basis of the reference information. The action of the owner X may be the current action, or may be an action in the future. The estimation part 524 may store the information indicating the estimated action of the owner X or the information indicating the estimated return point in the storage part 530 in association with the estimated out-of-use period.

For example, the estimation part 524 estimates the out-of-use period on the basis of the action of the owner X in the target period. The action of the owner X in the target period may be, for example, a schedule registered by the schedule information 531, or may be an action estimated by the estimation part 524. In the case of the latter, the estimation part 524 may estimate the action of the owner X in the target period and estimate the out-of-use period on the basis of the estimated action of the owner X, for example, when the schedule of the target period is not registered.

For example, in the case in which the owner X gives only a usage instruction of the second service when the owner X alights from the automated driving vehicle, the estimation part 524 estimates the action after the owner X alights from the automated driving vehicle on the basis of the alighting place, time, or the like. For example, when there is a beauty salon which the owner X has visited in the past near the alighting place, the estimation part 524 may estimate that the owner X went to the beauty salon, and estimate the time required at an average beauty salon from the current time as the out-of-use period.

In addition, the estimation part 524 estimates the action of the owner X in the target period on the basis of the attribute information 537 of the owner X. For example, the estimation part 524 may set an action range to be narrow when the owner X is a housewife and set an action range to be wide when the owner X is a company employee, and estimate the action of the owner X within the set range.

In addition, the estimation part 524 estimates the action of the owner X in the target period on the basis of the contribution information. For example, the estimation part 524 may estimate an action such as shopping, being at a restaurant, having friends, going to a concert, or the like, by analyzing the image contributed by the owner X. In addition, the estimation part 524 may estimate emotions or thoughts of the owner X by analyzing the contributed text or sound, and estimate the future action of the owner X on the basis of the estimated result. For example, when it is estimated that the owner X is excited with a friend, it is estimated that the owner X will continue to be with the friend.

In addition, the estimation part 524 acquires an action pattern of the owner X on the basis of the schedule information 531, and estimates the action of the owner X on the basis of the acquired action pattern. The estimation part 524 may estimate the out-of-use period on the basis of the estimated action of the owner X, and may estimate the out-of-use period on the basis of the acquired action pattern. For example, when an action pattern of commuting to an office on an electric train on weekdays and going out using the automated driving vehicle on weekends is estimated, the estimation part 524 estimates the weekday as the out-of-use period. Further, when a going-out schedule is scheduled in a weekday schedule, the estimation part 524 may estimate that a period in which out-of-going is scheduled is not an out-of-use period.

In addition, the estimation part 524 may estimate the out-of-use period on the basis of information related to a coordinating partner, for example, when a schedule of a target period is not registered. The adjustment partner includes, for example, a family member of the owner X, a companion or the like with the owner X. The information related to the adjustment partner includes, for example, a schedule of the adjustment partner, an action or an action pattern of the adjustment partner, contribution information of the adjustment partner, and the like. The estimation part 524 may read the information related to the adjustment partner from the storage part 530, may acquire the information from another external server, and may be estimated using the same method as the method of estimating the information related to the owner X.

The determination part 525 sets the out-of-use period estimated by the estimation part 524 to a period in which the second service can be provided by the service management device 500 (hereinafter, a service period). The determination part 525 may transmit a confirmation note configured to check whether the service may be provided in the out-of-use period estimated by the estimation part 524 to the vehicle control device 5 or the terminal device 300, determine a service period under a condition that agreement of the owner X is obtained, or determine a service period without agreement of the owner X. For example, agreement of the owner X is needed when the service period is set to a time period (daytime) in which the owner X frequently uses the automated driving vehicle, and agreement of the owner X may not be needed in a time period (nighttime) in which the owner X uses the automated driving vehicle at a low frequency. Further, the determination part 525 may set a period that matches a service condition in the out-of-use period estimated by the estimation part 524 as the service period with reference to the service conditions information 532.

The determination part 525 sets a finish time of the service period to a returning time of the automated driving vehicle.

The determination part 525 determines a second service (hereinafter, referred to as a service to be provided) provided in the out-of-use period estimated by the estimation part 524. The determination part 525 may determine the service to be provided with respect to the set service period, or may determine the service to be provided in some or all of the plurality of out-of-use periods that are candidates for the service period.

For example, the determination part 525 determines any one of one or more second services (hereinafter, referred to as a service candidate) in which the automated driving vehicle can return to the designated return point at the finish time of the service period as the service to be provided. The determination part 525 determines the service candidate on the basis of usage limitation when there is a usage limitation according to each second service. For example, the cleaning service has restrictions on the number of cleaning facilities provided, the number of vehicles that can be cleaned at each cleaning facility, or the like. For this reason, the determination part 525 acquires information related to a usage status of the cleaning facility from the cleaning management server 700, and determines a service candidate on the basis of the acquired information. In addition, in the car sharing service, space for stopping or parking the shared car may be limited. For this reason, the determination part 525 acquires information related to the shared car and a usage status of a space in which the shared car is stopped or parked from the allocation management server 900, and determines a service candidate on the basis of the acquired information.

For example, the determination part 525 notifies the owner X of a service candidate by transmitting the information related to the service candidate to the vehicle control device 5 or the terminal device 300 using the communication part 510. The information related to the service candidate is information indicating attributes of the second service included in the service candidate, and for example, includes details of the second service included in the service candidate, a time required for the second service included in the service candidate, permissibility for change indicating easiness of change of the second service included in the service candidate, and the like. The details of the second service include, for example, a type of second service, a position on a map of a facility used, an area of a traveling route, a destination set when traveling as a shared car or a taxi, and the like. The permissibility for change of the second service is, for example, information indicating flexibility when a service provider changes the schedule at the beginning while the second service is provided. For example, the permissibility for change is high when a usage status in the cleaning facility included in the service candidate is not congested, and the permissibility for change is low when the usage state is congested. The owner X can select the desired second service from a plurality of service candidates with reference to the attributes of the second service. The determination part 525 determines the second service selected by the owner X from the service candidates as the service to be provided on the basis of the information received from the vehicle control device 5 or the terminal device 300 using the communication part 510.

In addition, the determination part 525 may determine a second service that most closely matches the service conditions from the service candidates as the service to be provided with reference to the service conditions information 532. The second service that most matches the service condition includes, for example, a second service having the lowest ratio of an actual usage frequency with respect to a frequency defined as “a frequency of service” (a usage frequency desired by the owner X), a second service having a minimum difference between a length of a time defined as “a minimum time required” and a length of a service period determined by the determination part 525, a second service with the highest priority defined as “priority,” a second service having a largest service period included in the time period defined as “time period limitation,” and the like. In addition, the determination part 525 may compositely derive a degree of agreement with the service condition on the basis of a plurality of conditions, and determine the service to be provided on the basis of the derived degree.

In addition, the determination part 525 may determine a second service that matches a usage trend of the owner X from the service candidates as the service to be provided with reference to the usage history information 535. For example, the determination part 525 derives a day of the week and a time period having a high usage trend of each second service, and determines a second service in which a coinciding portion (a time length) between the derived day of the week and time period and the service period is largest as the service to be provided.

The determination part 525 may transmit the information related to the service to be provided to the vehicle control device 5 or the terminal device 300 using the communication part 510, obtain agreement of provision of the service to be provided during the service period from the owner X, and perform processing of providing the service to be provided when the agreement from the owner X is obtained. Further, when there is a person concerned with the service to be provided (for example, when the service period of the service to be provided is estimated on the basis of the information related to the adjustment partner), the determination part 525 may request the person concerned for the agreement to provide the service to be provided during the service period, and perform processing of providing the service to be provided when the agreement from the person concerned is obtained.

In addition, the determination part 525 may determine the service to be provided in the set service period when the service period is set in the schedule information 531 (for example, when “∘”, a type of the second service, a usage facility name, and the like, are described in the service schedule in association with a certain period). In addition, when the second service in the service period is previously set by the owner X, the determination part 525 may determine the set second service as the service to be provided.

In addition, in the determination part 525, when the strictness of the service period is set to be low, the second service may be determined as the service to be provided even if it is a second service that exceeds the service period.

During provision of the service, the determination part 525 derives a time (hereinafter, referred to as a service usage finish time) when usage of the service provided will terminate in order to return to the return point by the finish time of the service period on the basis of the current time and the current location of the automated driving vehicle. For example, when the service to be provided is a cleaning service, the service usage finish time is the latest time to leave the cleaning facility. When the service to be provided is a car sharing service or a taxi service, the service usage finish time is a time when traveling as a shared car or a taxi is terminated. For example, the determination part 525 calculates the service usage finish time backward from the finish time of the second service period on the basis of a total time obtained by adding a predetermined allowance time to a time when traveling from the current location of the automated driving vehicle or a destination (for example, a place of a cleaning facility or a destination set by a guest of a shared car or a taxi) to a return point. Further, the determination part 525 may derive the second service usage finish time on the basis of a traffic congestion in the route to the return point, a traffic congestion in the route to the destination, or the like. Then, the determination part 525 transmits the derived service usage finish time to the vehicle control device 5.

The determination part 525 determines a first action plan in the service period. The first action plan includes, for example, a destination, a traveling aspect, a traveling schedule, a traveling route, and the like. In addition, the first action plan includes information that allows the automated driving vehicle to travel, information of stopping or parking the automated driving vehicle for waiting, and the like. Further, items included in the first action plan may be different according to a type of the second service. The destination is a destination at which the second service is provided, and includes, for example, a location on a map of a cleaning facility, a location on a map of a space in which the shared car is able to stop or park, a location on a map of a charging station, and the like. The traveling aspect includes an aspect of traveling as an individual vehicle, an aspect of traveling as a taxi, and the like. When traveling as a taxi, the traveling aspect includes an aspect of traveling as a taxi that allows boarding of a guest who shows a boarding intension by raising a hand in the middle of traveling (hereinafter, referred to as a cruising taxi without customer on board), an aspect of traveling as a taxi that picks up a guest at a call point specified by the guest (hereinafter, referred to as a call taxi), or the like. The traveling schedule and the traveling route are items that are mainly set in the taxi service. The traveling schedule includes a priority or time of each traveling aspect. The traveling route includes a traveling area (a center before a station, a center of a town), a priority road (give priority to driving a main street), and the like. Further, the determination part 525 may refer the storage part 530 and change the first action plan while the provided second service is provided (i.e., in the middle of the second service period).

The correction part 526 corrects the out-of-use period estimated by the estimation part 524, and corrects the out-of-use period determined in the service period by the determination part 525. The correction part 526 may correct the out-of-use period before provision of the second service is started, or correct the out-of-use period while the second service is being provided.

The correction part 526 determines whether a predetermined correction condition is satisfied, and corrects the out-of-use period when the correction condition is satisfied. For example, the correction part 526 determines whether the correction condition is satisfied on the basis of a difference between an action of the owner X referred to in determination of the service to be provided (hereinafter, referred to as a first action) and an action of the owner X acquired after determination of the service to be provided (hereinafter, referred to as a second action). Satisfying the correction condition includes, for example, the fact that the difference between the time required of the first action and the time required of the second action is equal to or greater than a predetermined time, the fact that a difference between the number of events in the first action and the number of events in the second action is equal to or greater than a predetermined number, and the like. The event is a matter executed by the owner X, and for example, shopping, beauty salon, meal, and the like. In addition, satisfying the correction condition may include occurrence of causes that cause the second action to be separated from the first action, and the like. The causes of the separation include, for example, the fact that the owner X has received a contact of requesting an emergency return.

The correction part 526 corrects the out-of-use period on the basis of the second action when the correction condition is satisfied. For example, when the first action is “two hours shopping” and the second action is “three hours shopping,” the correction part 526 extends the out-of-use period by one hour.

The correction part 526 may transmit the information related to the correction contents to the vehicle control device 5 or the terminal device 300 using the communication part 510, ask the owner X (or a person concerned) for an agreement to change the service to be provided, and change the service to be provided when the agreement is obtained from the owner X (or a person concerned).

The cleaning management part 527 communicates with the allocation management server 900 using the communication part 510, transmits a request instruction of retrieval of the cleaning facility according to a request of the owner X, and receives the retrieval result. The cleaning management part 527 determines the cleaning facility that matches the service condition from the retrieval result with reference to the service conditions information 532 of the storage part 530.

The allocation management part 528 refers to the storage part 530, retrieves the automated driving vehicle that matches the allocation request received from the allocation management server 900 (or a guest), and transmits call information to the automated driving vehicle obtained by the retrieval. The automated driving vehicle that matches the allocation request is a vehicle that satisfies, for example, an allocation condition, among a plurality of automated driving vehicles, previously registered in the storage part 530. The allocation conditions include, for example, conditions that a reservation number of people is equal or smaller than the capacity, it is possible to arrive at the call place by the waiting time, and it is possible to return to the return point before the finish time of the service period after traveling as a taxi to the destination. In addition, the allocation condition may include satisfying the service condition. Satisfying the service condition includes, for example, conditions that attributes of a guest who calls a taxi satisfy a user limitation of the service condition, a destination is within a range of area limitation, and the like.

The call information includes a call place, a number of reserved people, and a destination, attribute information (smoker, pet companion, or the like) of a guest, a main address of the guest, identification information assigned to the guest, a reservation number, and the like. The allocation management part 528 generates call information on the basis of an allocation request from the allocation management server 900.

The charging management part 529 comes in communication with a management server (not shown) configured to manage a charging station or the like using the communication part 510, transmits a request instruction of retrieval of the charging station or the like according to a request of the owner X, and receives the retrieval result. The charging management part 529 determines the charging station or the like that matches the service condition from the retrieval result with reference to the service conditions information 532 of the storage part 530.

### [Vehicle Control Device 5]

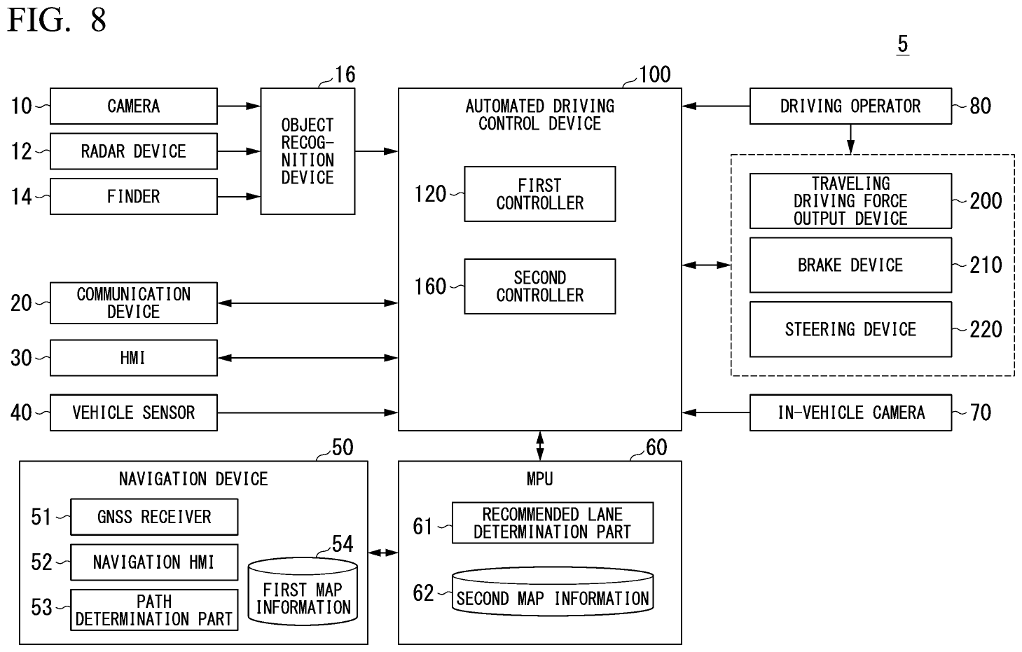

Next, the vehicle control device 5 will be described. FIG. 8 is a configuration view of the vehicle control device 5 according to the embodiment. A vehicle on which the vehicle control device 5 is mounted is, for example, a two-wheeled, three-wheeled or four-wheeled vehicle, and a driving source thereof is an internal combustion engine such as a diesel engine, a gasoline engine, or the like, an electric motor, or combinations thereof. The electric motor is operated using a generated output by a generator connected to the internal combustion engine, or a discharged output of a secondary battery or a fuel cell.

The vehicle control device 5 includes, for example, a camera 10, a radar device 12, a finder 14, an object recognition device 16, a communication device 20, a human machine interface (HMI) 30, a vehicle sensor 40, the navigation device 50, a map positioning unit (MPU) 60, an in-vehicle camera 70, a driving operator 80, an automated driving control device 100, a traveling driving force output device 200, a brake device 210 and a steering device 220. These devices or instruments are connected to each other by a multiple communication line such as a controller area network (CAN) communication line or the like, a serial communication line, a wireless communication network, or the like. Further, the configuration shown in FIG. 8 is merely an example, a part of the configuration may be omitted, and another configuration may be added.

The camera 10 is, for example, a digital camera using a solid-state image sensing device such as a charge coupled device (CCD), a complementary metal oxide semiconductor (CMOS), or the like. The camera 10 is attached to an arbitrary place of the automated driving vehicle on which the vehicle control device 5 is mounted. When a side in front of the vehicle is imaged, the camera 10 is attached to an upper section of a front windshield, a rear surface of a rearview mirror, or the like. The camera 10 images, for example, a periphery of the automated driving vehicle repeatedly periodically. The camera 10 may be a stereo camera.

The radar device 12 radiates radio waves such as millimeter waves or the like to surroundings of the automated driving vehicle, and simultaneously, detects the radio waves (reflected waves) reflected by the object to detect a position (a distance and an azimuth) of at least the object. The radar device 12 is attached to an arbitrary place of the automated driving vehicle. The radar device 12 may detect a position and a velocity of the object using a frequency modulated continuous wave (FM-CW) method.

The finder 14 is light detection and ranging (LIDAR). The finder 14 radiates light to surroundings of the automated driving vehicle, and measures the scattered light. The finder 14 detects a distance to a target on the basis of a time from emission to reception of light. The radiate light is, for example, a pulse-shaped laser beam. The finder 14 is attached to an arbitrary place of the automated driving vehicle.

The object recognition device 16 recognizes a position, a type, a velocity, or the like, of the object by performing sensor fusion processing with respect to the detection result by some or all of the camera 10, the radar device 12, and the finder 14. The object recognition device 16 outputs the recognized result to the automated driving control device 100. The object recognition device 16 may output the detection results of the camera 10, the radar device 12 and the finder 14 to the automated driving control device 100 as they are. The object recognition device 16 may be omitted from the vehicle control device 5.

The communication device 20 uses, for example, a cellular network, a Wi-Fi network, a Bluetooth (registered trademark), dedicated short range communication (DSRC), or the like, comes in communication with another vehicle present in the vicinity of the automated driving vehicle, or comes in communication with various server devices via a radio base station.

The HMI 30 receives an input operation by an occupant in the automated driving vehicle while providing various types of information to the occupant. The HMI 30 includes various display devices, a speaker, a buzzer, a touch panel, a switch, a key, and the like.

The vehicle sensor 40 includes a vehicle speed sensor configured to detect a velocity of the automated driving vehicle, an acceleration sensor configured to detect an acceleration, a yaw rate sensor configured to detect an angular velocity around a vertical axis, an azimuth sensor configured to detect a direction of the automated driving vehicle, and the like.

The navigation device 50 includes, for example, a GNSS receiver 51, a navigation HMI 52 and a path determination part 53. The navigation device 50 holds first map information 54 in a storage device such as an HDD, a flash memory, or the like. The GNSS receiver 51 specifies a position of the automated driving vehicle on the basis of a signal received from the GNSS satellite. The position of the automated driving vehicle may be specified or complemented by an inertial navigation system (INS) that uses output of the vehicle sensor 40. The navigation HMI 52 includes a display device, a speaker, a touch panel, a key, and the like. The navigation HMI 52 may be partially or entirely shared with the HMI 30 described above. The path determination part 53 determines, for example, a path (hereinafter, a path on a map) from a position of the automated driving vehicle specified by the GNSS receiver 51 (alternatively, an input arbitrary position) to a destination input by an occupant using the navigation HMI 52 with reference to the first map information 54. The first map information 54 is, for example, information in which a road shape is expressed by a link showing a road and a node connected by the link. The first map information 54 may include a curvature of a road, point of interest (POI) information, or the like. The path on a map is output to the MPU 60. The navigation device 50 may perform path guidance using the navigation HMI 52 on the basis of the path on a map. The navigation device 50 may be realized by, for example, a function of a terminal device such as a smart phone, a tablet terminal, or the like, held by the occupant. The navigation device 50 may transmit the current position and the destination to the navigation server via the communication device 20, and may acquire an equivalent path as the path on a map from the navigation server.

The MPU 60 includes, for example, a recommended lane determination part 61, and holds second map information 62 in a storage device such as an HDD, a flash memory, or the like. The recommended lane determination part 61 divides the path on a map provided from the navigation device 50 into a plurality of blocks (for example, divided at each 100 [m] in an advance direction of the vehicle), and determinations a recommended lane for each block with reference to the second map information 62. The recommended lane determination part 61 performs determination such as which lane from the left the vehicle travels. The recommended lane determination part 61 determines a recommended lane so that the automated driving vehicle can travel a reasonable path to proceed to a branch destination when a diverging point is present on the path on a map.

The second map information 62 is map information that is more accurate than the first map information 54. The second map information 62 includes, for example, information of a center of a lane, information of a boundary of a lane, or the like. In addition, the second map information 62 may include road information, traffic regulation information, address information (address/zip code), facility information, telephone number information, and the like. The second map information 62 may be updated at any time by bringing the communication device 20 in communication with another device.

The in-vehicle camera 70 is, for example, a digital camera using a solid-state image sensing device such as a CCD, a CMOS, or the like. The in-vehicle camera 70 is attached to an arbitrary place to image the inside of the automated driving vehicle.

The driving operator 80 includes, for example, an acceleration pedal, a brake pedal, a shift lever, a steering wheel, a modified steer, a joystick, and other operators. A sensor configured to detect an operation amount or existence of an operation is attached to the driving operator 80, and the detection result is output to some or all of the automated driving control device 100, the traveling driving force output device 200, the brake device 210, and the steering device 220.

The automated driving control device 100 includes, for example, a first controller 120 and a second controller 160. The first controller 120 and the second controller 160 are realized by executing a program (software) using a hardware processor such as a CPU or the like. In addition, some or all of these components may be realized by hardware (a circuit part; including a circuitry) such as LSI, ASIC, FPGA, GPU, or the like, or may be realized by cooperation of software and hardware. The program may be previously stored in a storage device such as an HDD, a flash memory, or the like, of the automated driving control device 100, stored in a detachable storing medium such as a DVD, a CD-ROM, or the like, or installed on an HDD or a flash memory of the automated driving control device 100 by mounting a storing medium on a drive device.

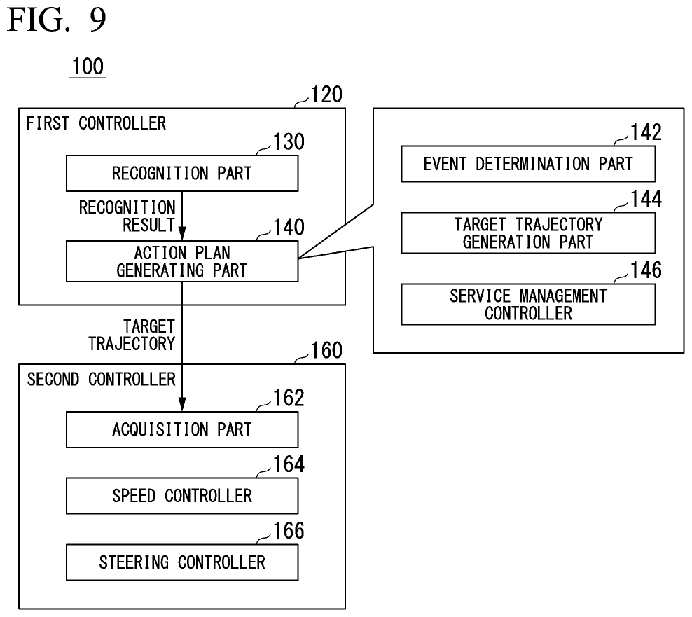

FIG. 9 is a functional configuration view of the first controller 120 and the second controller 160. The first controller 120 includes, for example, a recognition part 130 and an action plan generating part 140. The first controller 120 realizes both of a function of artificial intelligence (AI) and a function of a previously provided model in parallel. For example, regarding a function of “recognizing a crossroad”, a recognition of a crossroad through deep learning or the like and a recognition based on a predetermined condition (a signal, road markings, or the like that are able to be detected by pattern matching) may be executed in parallel, and the function of “recognizing a crossroad” may be realized by scoring and comprehensively evaluating them. Accordingly, reliability of automated driving is guaranteed.

The recognition part 130 recognizes a state such as a position, a velocity, an acceleration or the like, of an object around the automated driving vehicle on the basis of information input from the camera 10, the radar device 12, and the finder 14 via the object recognition device 16. For example, the position of the object is recognized as a position of absolute coordinates using a representative point (a center of gravity, a driving axial center, or the like) of the automated driving vehicle as an origin, and the position of the object is used for control. The position of the object may be represented by a representative point such as a center of gravity, a corner, or the like, of the object, or may be represented as a representative region. The “state” of the object may include an acceleration, a jerk, or “an action state” (for example, whether a lane change is performed or a lane change is planned to be performed) of the object.

In addition, the recognition part 130 recognizes, for example, a lane in which the automated driving vehicle is traveling (a traveling lane). For example, the recognition part 130 recognizes a traveling lane by comparing a pattern (for example, arrangement of solid lines and broken lines) of road marking lines obtained from the second map information 62 with a pattern of road mark lines around the automated driving vehicle recognized from an image captured by the camera 10. Further, the recognition part 130 may recognize a traveling lane by recognizing traveling lane boundaries (road boundaries) including road mark lines, road shoulders, curbstones, median strips, guardrails, and the like, while not being limited to road marking lines. In such recognition, a position of the automated driving vehicle acquired by the navigation device 50 or a processing result by the INS may be added. In addition, the recognition part 130 recognizes a temporary stop line, an obstacle, a red signal, a tollgate, and other road events.

The recognition part 130 recognizes a position or an attitude of the automated driving vehicle with respect to the traveling lane when the traveling lane is recognized. The recognition part 130 may recognize, for example, a separation from a lane center of a reference point of the automated driving vehicle and an angle with respect to a line that connects a center of the lane of the automated driving vehicle in an advance direction as a relative position and an attitude of the automated driving vehicle with respect to the traveling lane. Instead of this, the recognition part 130 may recognize a position or the like of a reference point of the automated driving vehicle with respect to any side end portion (a road mark line or a road boundary) of the traveling lane as a relative position of the automated driving vehicle with respect to the traveling lane.

The action plan generating part 140 may generate, for example, a second action plan of the automated driving vehicle in the service period according to the service managed by the service management device 500. The second action plan includes information of causing the automated driving vehicle to travel, information of stopping or parking the automated driving vehicle for waiting, and the like. Further, the first action plan is a rough action plan determined to execute the service, and the second action plan is a detailed action plan to travel or stop the automated driving vehicle. The second action plan includes an automated driving event determined by an event determination part 142, a target trajectory generated by a target trajectory generating part 144, or the like.

The action plan generating part 140 includes, for example, the event determination part 142, the target trajectory generating part 144 and a service management controller 146. The event determination part 142 determines an automated driving event in a path in which the recommended lane is determined. The event is information that prescribes a traveling aspect of the automated driving vehicle. The automated driving event is a fixed speed traveling event, a low speed following traveling event, a lane change event, a diverging event, a merging event, a take-over event, or the like. In addition, the event determination part 142 may change the previously determined event to another event or determine a new event according to a surrounding situation recognized by the recognition part 130 when the automated driving vehicle is traveling.

The target trajectory generating part 144 generates a future target trajectory that causes the automated driving vehicle to travel automatically (independent of a driver's operation) with an traveling aspect prescribed by the event so that the automated driving vehicle travels the recommended lane determined by the recommended lane determination part 61 in principle, and further, so that the automated driving vehicle can correspond to a surrounding situation when the automated driving vehicle travels the recommended lane. The target trajectory includes, for example, a position element that determines a future position of the automated driving vehicle, and a velocity element that determines a future velocity or the like of the automated driving vehicle. For example, the target trajectory generating part 144 generates a target trajectory according to an event started by the event determination part 142.

For example, the target trajectory generating part 144 determines a plurality of points (trajectory points) at which the automated driving vehicle should arrive in sequence as a position element of the target trajectory. The trajectory point is a point at which the automated driving vehicle should arrive at each of predetermined traveling distances (for example, about every several [m]). The predetermined traveling distance may be calculated, for example, by a road distance traveled along the path.

In addition, the target trajectory generating part 144 determines a target velocity and a target acceleration of each predetermined sampling time (for example, about every several fractions of a [sec]) as a velocity element of the target trajectory. In addition, the trajectory point may be a position at which the automated driving vehicle should arrive at a specific sampling time among predetermined sampling times. In this case, the target velocity or the target acceleration is determined by interval between the sampling times and the trajectory points. The target trajectory generating part 144 outputs the information indicating the generated target trajectory to the second controller 160.

The service management controller 146 causes the automated driving vehicle to travel in the service period determined by the service management device 500, and causes the automated driving vehicle to travel so as to return to the return point until the finish time of the service period. For example, the service management controller 146 causes the automated driving vehicle to travel towards a cleaning facility, a call place of a taxi, a charging station, or the like, according to an instruction by the service management device 500 (alternatively, according to the first action plan created by the service management device 500). Here, for example, the service management controller 146 instructs the navigation device 50 to determine a path until the destination on the basis of the first action plan received from the service management device 500. Accordingly, the MPU 60 determines a recommended lane, the event determination part 142 determines an event, or the target trajectory generating part 144 generates a target trajectory. Since the second controller 160 controls the devices on the basis of the information output from the first controller 120 through such processing, the automated driving vehicle can travel according to the first action plan.

In addition, the service management controller 146 monitors whether the service usage finish time is reached on the basis of the service usage finish time received from the service management device 500. When the service usage finish time is reached (exactly that time or when that time has passed, the same applied hereinafter), the service management controller 146 terminates or interrupts the service and causes the automated driving vehicle to travel toward the return point.

In this way, the action plan generating part 140 can generate a second action plan that causes the automated driving vehicle to travel or stop according to the first action plan instructed by the service management device 500. For example, the service management controller 146 causes the automated driving vehicle to travel along an optimal path to the cleaning facility, and causes the automated driving vehicle to travel along an optimal path to the return point when the cleaning in the cleaning facility is terminated. In addition, the service management controller 146 may cause the automated driving vehicle to travel as a cruising taxi having no customer on board until there is a call from a guest, and cause the automated driving vehicle to travel as a call taxi when there is a call from a guest. In addition, the service management controller 146 may temporarily terminate the traveling as the taxis and park the automated driving vehicle in a parking lot until the return time when the period in which the guest is not captured during traveling as the cruising taxi having no customer on board exceeds the predetermined period or more.

The second controller 160 controls the traveling driving force output device 200, the brake device 210, and the steering device 220 such that the automated driving vehicle passes the target trajectory generated by the action plan generating part 140 at the time of the schedule.

Returning to FIG. 9, the second controller 160 includes, for example, an acquisition part 162, a speed controller 164 and a steering controller 166. The acquisition part 162 acquires information of the target trajectory (the trajectory point) generated by the action plan generating part 140, and stores the information in a memory (not shown). The speed controller 164 controls the traveling driving force output device 200 or the brake device 210 on the basis of the velocity element accompanying with the target trajectory stored in the memory. The steering controller 166 controls the steering device 220 according to a curving condition of the target trajectory stored in the memory. Processing of the speed controller 164 and the steering controller 166 is realized by, for example, combination of feedforward control and feedback control. As an example, the steering controller 166 is executed by combination of feedforward control according to a curvature of a road in front of the automated driving vehicle and feedback control on the basis of the separation from the target trajectory.

The traveling driving force output device 200 outputs a traveling driving force (torque) that causes the vehicle to travel to a driving wheel. The traveling driving force output device 200 includes, for example, combinations of an internal combustion engine, an electric motor, a transmission, and the like, and an ECU configured to control them. The ECU controls the above-mentioned configuration according to information input from the second controller 160 or information input from the driving operator 80.

The brake device 210 includes, for example, a brake caliper, a cylinder configured to transmit a hydraulic pressure to the brake caliper, an electric motor configured to generate a hydraulic pressure in the cylinder, and a brake ECU. The brake ECU controls the electric motor according to the information input from the second controller 160 or the information input from the driving operator 80 such that a braking torque is output to each wheel according to a braking operation. The brake device 210 may include a mechanism configured to transmit a hydraulic pressure generated according to an operation of a brake pedal included in the driving operator 80 to the cylinder via a master cylinder as a back-up. Further, the brake device 210 is not limited to the above-mentioned configuration and may be an electronically controlled hydraulic brake device configured to control an actuator according to the information input from the second controller 160 and transmit a hydraulic pressure of the master cylinder to the cylinder.

The steering device 220 includes, for example, a steering ECU and an electric motor. The electric motor changes an orientation of a steered wheel by, for example, applying a force to a rack and pinion mechanism. A steering ECU drives the electric motor and changes an orientation of the steered wheel according to the information input from the second controller 160 or the information input from the driving operator 80.

### [Sequence Diagram]

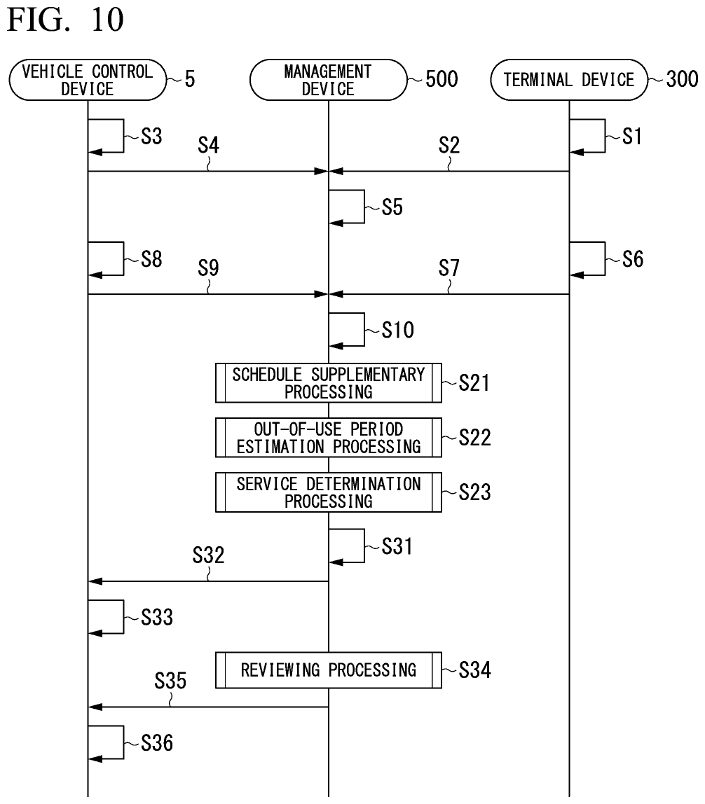

Hereinafter, a flow of a series of processing by the vehicle control system 1 of the embodiment will be described using a sequence diagram. FIG. 10 is a sequence diagram showing an example of a flow of a series of processing by the vehicle control system 1 according to the embodiment. For example, processing of the sequence diagram may be repeatedly performed at a predetermined cycle.

First, a usage schedule of the automated driving vehicle is input by the owner X using the terminal device 300 (step S1). The terminal device 300 transmits information indicating a usage schedule of the automated driving vehicle to the service management device 500 via a network NW on the basis of an operation by the owner X (step S2). In addition, the owner X may input a usage schedule of the automated driving vehicle using the HMI 30 of the vehicle control device 5 (step S3). The vehicle control device 5 transmits information indicating the usage schedule of the automated driving vehicle to the service management device 500 via the network NW on the basis of the operation by the owner X (step S4). The service management device 500 updates the schedule information 531 of the storage part 530 on the basis of the information received from the terminal device 300 or the vehicle control device 5 (step S5).

Next, the owner X inputs a service condition of the automated driving vehicle using the terminal device 300 (step S6). The terminal device 300 transmits the information indicating the service condition to the service management device 500 via the network NW on the basis of the operation by the owner X (step S7). In addition, the owner X may input the service condition of the automated driving vehicle using the HMI 30 of the vehicle control device 5 (step S8). The vehicle control device 5 transmits the information indicating the service condition to the service management device 500 via the network NW on the basis of the operation by the owner X (step S9). The service management device 500 updates the service conditions information 532 of the storage part 530 on the basis of the received information (step S10).

Next, the service management device 500 executes schedule supplement processing and updates the schedule information 531 on the basis of the created supplementary schedule (step S21), and the schedule supplement processing will be described below in detail. The service management device 500 executes an out-of-use period estimation processing of estimating an out-of-use period (step S22). The out-of-use period estimation processing will be described below in detail. Then, the service management device 500 executes the service determination processing (step S23). The service determination processing will be described below in detail.

Next, it is determined whether it is before the predetermined time of the starting time of the service to be provided determined by the service determination processing (step S31). When it is before the predetermined time of the starting time of the service to be provided, the service management device 500 starts processing to provide the service to be provided, and transmits various instructions to the vehicle control device 5 (step S32). The vehicle control device 5 controls the automated driving vehicle on the basis of the instruction received from the service management device 500 (step S33).

While the service to be provided is provided, the service management device 500 executes reviewing processing (step S34). When the correction condition is satisfied in the reviewing processing, the service management device 500 corrects details of the service to be provided and transmits the correction contents to the vehicle control device 5 (step S35). The vehicle control device 5 controls the automated driving vehicle on the basis of the correction contents received from the service management device 500 (step S36).

### [Processing Flow]

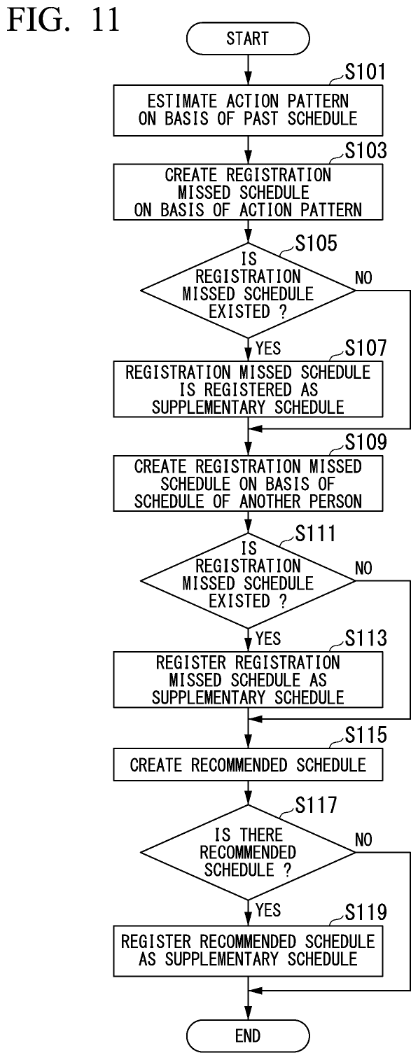

Hereinafter, a flow of each processing by the service management device 500 of the embodiment will be described using a flowchart. FIG. 11 is a flowchart showing an example of the schedule supplement processing by the service management device 500. The processing of the flowchart is performed by each automated driving vehicle.

The schedule management part 521 refers to the schedule information 531, and estimates an action pattern of the owner X on the basis of the past schedule of the owner X (step S101). The schedule management part 521 creates a registration missed schedule on the basis of the estimated action pattern with respect to a period in which a schedule is not planned in the schedule indicated by the schedule information 531 (step S103). In step S103, when there is no supplementary schedule in the period in which the schedule is not planned, the schedule management part 521 may not need to create the registration missed schedule. In step S103, when the registration missed schedule is created (step S105), the schedule management part 521 registers the created registration missed schedule in the schedule information 531 as the supplementary schedule (step S107).

Next, the schedule management part 521 refers to the schedule information 531, and creates the registration missed schedule on the basis of the schedule in the past of the user related to the owner X (step S109). In step S109, when there is no supplementary schedule in the period in which the schedule is not planned, the schedule management part 521 may not create the registration missed schedule. In step S109, when the registration missed schedule is created (step S111), the schedule management part 521 registers the created registration missed schedule in the schedule information 531 as the supplementary schedule (step S113).

Next, the schedule management part 521 refers to the schedule information 531, the owner status information 536, the attribute information 537, and the like, and creates the recommendation schedule (step S115). In step S115, when there is no recommendation schedule in the period in which the schedule is not planned, the schedule management part 521 may not create the recommendation schedule. In step S115, when the recommendation schedule is created (step S117), the schedule management part 521 registers the created recommendation schedule in the schedule information 531 as the supplementary schedule (step S119).

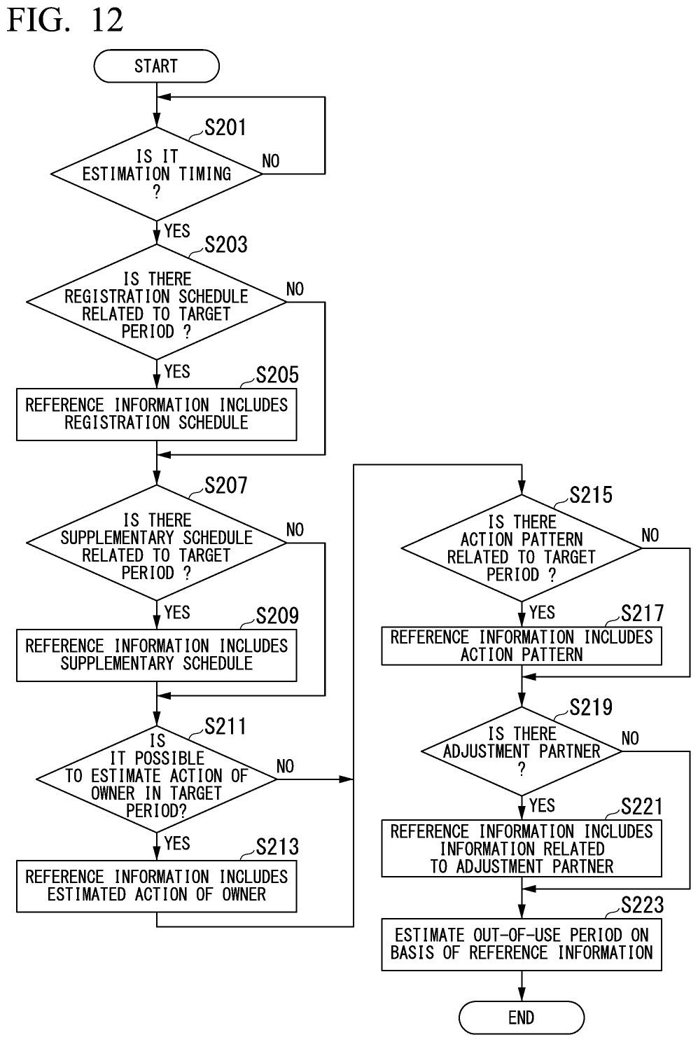

Next, a flow of the out-of-use period estimation processing by the service management device 500 according to the embodiment will be described using a flowchart. FIG. 12 is a flowchart showing an example of a flow of the out-of-use period estimation processing by the service management device 500. The processing of the flowchart is performed in each target period of each automated driving vehicle.

First, the estimation part 524 determines whether it is an estimation timing in the target period (step S201). The estimation timing includes, for example, a predetermined time, a timing when the owner X alights from the automated driving vehicle, a timing before a predetermined time of an alighting time designated by the owner X, a timing when provision of the second service is desired by the owner X, and the like. The target period includes, for example, the next morning, 12 hours after alighting, 12 hours after the second service is desired to be provided, and the like.

When it is an estimation timing, the estimation part 524 refers to the schedule information 531, and determines whether there is a registered schedule related to the target period (including an owner schedule and a service schedule) (step S203). “The registered schedule related to the target period” may be within the target period, and may be a schedule that is scheduled within a period including a predetermined period before and after the target period. When there is a registered schedule related to the target period, the estimation part 524 includes the registered schedule in the reference information (step S205).

Next, the estimation part 524 refers to the schedule information 531, and determines whether there is a supplementary schedule related to the target period (step S207). When there is a supplementary schedule related to the target period, the estimation part 524 includes the supplementary schedule in the reference information (step S209).

Next, the estimation part 524 determines whether the action of the owner X can be estimated in the target period (step S211). When the action of the owner X can be estimated, the estimation part 524 includes the estimated action of the owner X in the reference information (step S213).

Next, the estimation part 524 acquires the action pattern of the owner X, and determines whether there is an action pattern related to the target period (step S215). When there is an action pattern related to the target period, the estimation part 524 includes the action pattern in the reference information (step S217).

Next, the estimation part 524 refers to the schedule information 531, and determines whether there is an adjustment partner who requires adjusting the schedule in the target period (step S219). When there is an adjustment partner, the estimation part 524 includes the information related to the adjustment partner in the reference information (step S221). Then, the estimation part 524 estimates the out-of-use period on the basis of the reference information (step S223).

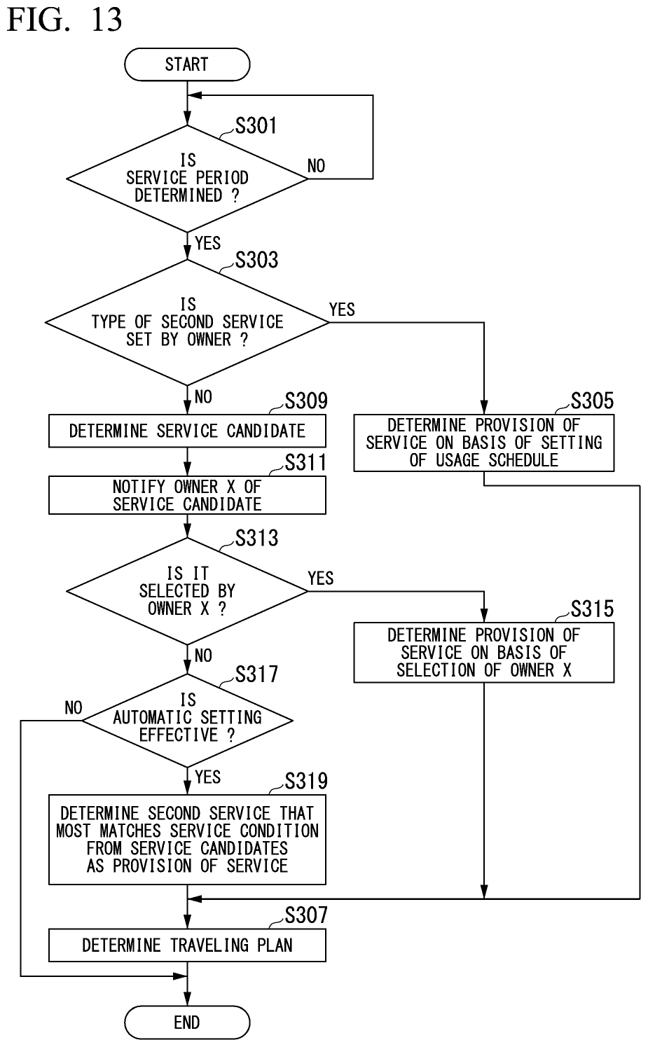

Next, a flow of service determination processing by the service management device 500 of the embodiment will be described using a flowchart. FIG. 13 is a flowchart showing an example of a flow of service determination processing by the service management device 500. The processing of the flowchart is performed by each automated driving vehicle.

The determination part 525 determines the service period when it is the predetermined timing (step S301). The predetermined timing is, for example, a timing when the schedule information 531 is updated, a timing when it is a predetermined designated time (2 a.m. every day), or the like. When the service period is determined, the determination part 525 determines whether a type of the second service in the determined service period is set by the owner X (step S303). For example, when the type of the second service in the service period is designated in the usage schedule of the automated driving vehicle, the determination part 525 determines the designated type of the second service as the service to be provided (step S305), and determines the first action plan according to the determined service to be provided (step S307). The determination part 525 registers the determined service to be provided or the information related to the first action plan in the usage history information 535 of the storage part 530.

In step S303, when the type of the second service in the service period is not set, the determination part 525 determines one or more service candidates in the service period (step S309). Then, the determination part 525 transmits the information indicating the service candidate to the terminal device 300 or the vehicle control device 5, and notifies the owner X of the information (step S311). Next, the determination part 525 determines whether any one of the service candidates is selected by the owner X (step S313). When the information indicating any one of the service candidates is received from the terminal device 300 or the vehicle control device 5, the determination part 525 determines the service candidate selected by the owner X as the service to be provided (step S315), and determines the first action plan according to the determined service to be provided (step S307).

In step S313, when any one of the service candidates is not selected by the owner X within the predetermined time after the service candidate is notified to the owner X, the service management device 500 determines whether automatic setting is effective (step S317). The automatic setting being effective indicates a situation in which the owner X has agreed that the determination part 525 determines an optimal second service as the service to be provided. When the automatic setting is effective, for example, the determination part 525 determines the second service that most matches the service condition from the service candidates as the service to be provided (step S319), and determines the first action plan according to the determined service to be provided (step S307).

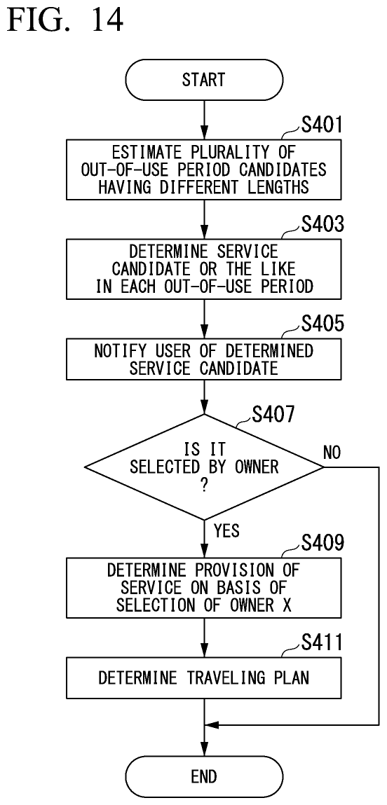

Next, another example of service determination processing by the service management device 500 of the embodiment will be described. FIG. 14 is a flowchart showing another example of service determination processing by the service management device 500. The processing of the flowchart is performed by each automated driving vehicle.

First, the estimation part 524 estimates a plurality of out-of-use period candidates having different lengths (step S401). For example, the estimation part 524 estimates out-of-use period candidates such as a course of two hours, a course of four hours, a course of 6 hours, and the like, from a time when the owner X alights from the automated driving vehicle. Next, the determination part 525 determines the service candidate on each of the out-of-use period candidates estimated in step S401 (step S403), transmits the information indicating the service candidate to the terminal device 300 or the vehicle control device 5, and notifies the owner X of the information (step S405).

Next, the determination part 525 determines whether any one of the service candidates is selected by the owner X (step S407). When the information indicating any one of the service candidates is received from the terminal device 300 or the vehicle control device 5, the determination part 525 determines the service candidate selected by the owner X as the service to be provided (step S409), and determines the first action plan according to the determined service to be provided (step S411).

Further, while detailed description thereof is omitted, the determination part 525 may determine the second service that most matches the service condition from the determined service candidates as the service to be provided in step S403.

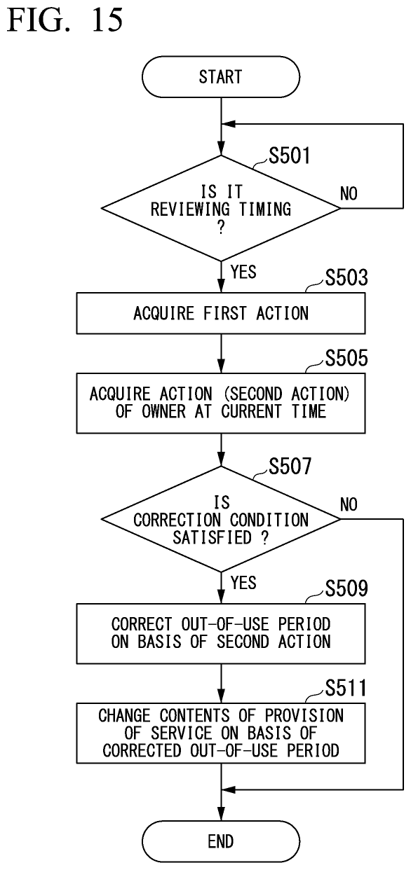

Next, a flow of reviewing processing by the service management device 500 of the embodiment will be described with reference to a flowchart. FIG. 15 is a flowchart showing an example of a flow of the reviewing processing by the service management device 500. The processing of the flowchart is performed by each automated driving vehicle.

First, the correction part 526 determines whether it is the reviewing timing for the service to be provided that is being provided (step S501). The reviewing timing includes, for example, a predetermined time, a timing when the owner status information 536 is updated, and the like. When it is the reviewing timing, the correction part 526 acquires the first action referenced when the service to be provided that is being provided is determined, with reference to the schedule information 531, the owner status information 536, or the like (step S503). Next, the correction part 526 acquires (or estimates) an action of the owner X at the current time as the first action while referring to the schedule information 531, the owner status information 536, or the like (step S505).

Next, the correction part 526 determines whether the correction condition is satisfied on the basis of the first action and the second action (step S507). When it is determined that the correction condition is satisfied, the correction part 526 corrects the out-of-use period on the basis of the second action (step S509). Then, the determination part 525 changes the first action plan on the basis of the out-of-use period corrected by the correction part 526 (step S511).

According to the above-mentioned embodiment, since the out-of-use period in which the automated driving vehicle is not used by the user is estimated on the basis of the reference information including the usage schedule of the automated driving vehicle by the user, and the service management part 520 configured to manage the predetermined service provided in a state in which the user does not use the automated driving vehicle in the estimated out-of-use period and the service management controller 146 configured to cause the automated driving vehicle to automatically travel according to the predetermined service managed by the service management part are provided, the automated driving vehicle can be widely used by a user other than the owner.

### [Hardware Configuration]

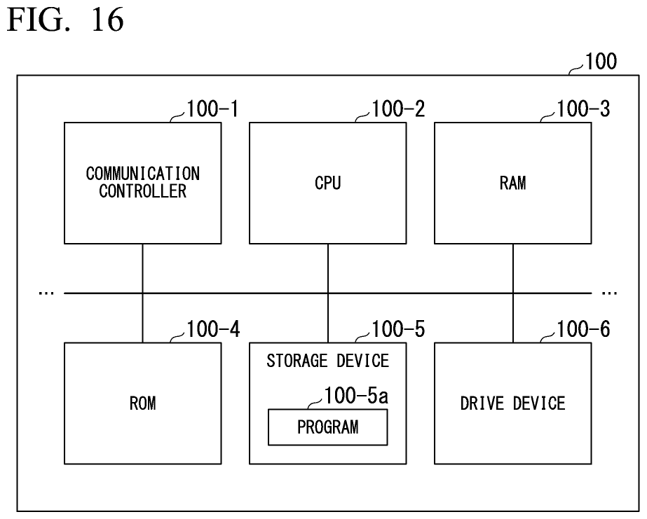

FIG. 16 is a view showing an example of a hardware configuration of the automated driving control device 100 of the embodiment. As shown, the automated driving control device 100 has a configuration in which a communication controller 100-1, a CPU 100-2, a RAM 100-3 used as a working memory, a ROM 100-4 in which a boot program or the like is stored, a storage device 100-5 such as a flash memory, an HDD, or the like, and a drive device 100-6 are connected to each other by an internal bus or a dedicated communication line. The communication controller 100-1 performs communication with components other than the automated driving control device 100. A program 100-5a executed by the CPU 100-2 is stored in the storage device 100-5. The program is expanded in the RAM 100-3 by a direct memory access (DMA) controller (not shown) or the like and executed by the CPU 100-2. Accordingly, a part or all of the first controller 120 and the second controller 160 are realized.

Hereinabove, while aspects of performing the present invention have been described using the embodiment, the present invention is not limited to the above-mentioned embodiment, and various modifications and substitutions may be made without departing from the scope of the present invention.

For example, at least one of the service management device 500 and the vehicle control device 5 may determine a return point of the automated driving vehicle on the basis of the location information 533. For example, when the owner X is moved from a shopping mall, the determination part 525 may determine a position of the owner X after movement as a return point on the basis of the owner location information.

A part or all of the service management part 520 of the service management device 500 or a part or all of the information stored in the storage part 530 may be mounted on the vehicle control device 5, and a part or all of the service management controller 146 provided in the vehicle control device 5 may be provided in the service management device 500. That is, at least one of the service management part 520 and the service management controller 146 is included in “the controller” configured to cause the automated driving vehicle to automatically travel according to a predetermined service managed by the service management controller 146.

In addition, the second service is not limited to the above-mentioned service, and for example, may be a service of retrieving a cheaper parking lot and parking the vehicle, a service of returning to your home once and then picking you up, a service of sending adults to the company and then sending children to the cram school.

### REFERENCE SIGNS LIST

1 Vehicle control system

5 Vehicle control device

300 Terminal device

500 Service management device

700 Cleaning management server

900 Allocation management server

10 Camera

12 Radar device

14 Finder

16 Object recognition device

20 Communication device

30 HMI

40 Vehicle sensor

50 Navigation device

60 MPU

70 In-vehicle camera

80 Driving operator

100 Automated driving control device

120 First controller

130 Recognition part

140 Action plan generating part

142 Event determination part

144 Target trajectory generating part

146 Service management controller

160 Second controller

162 Acquisition part

164 Speed controller

166 Steering controller

200 Traveling driving force output device

210 Brake device

220 Steering device

510 Communication part

520 Service management part

530 Storage part

1. A vehicle control system comprising:
a service management device that is configured to estimate an out-of-use period in which a user does not use an automated driving vehicle on the basis of reference information including a usage schedule of the automated driving vehicle of the user, and that is configured to manage a predetermined service provided in a state in which the user is not using the automated driving vehicle in the estimated out-of-use period; and
a controller configured to generate an action plan of the automated driving vehicle in the out-of-use period according to the predetermined service managed by the service management device.

2. The vehicle control system according to claim 1, wherein the service management device estimates an action after the user alights from the automated driving vehicle, and includes the estimated action in the reference information.

3. The vehicle control system according to claim 1, wherein the service management device estimates an action pattern of the user, and includes the estimated action pattern of the user in the reference information.

4. The vehicle control system according to claim 1, wherein the service management device corrects the out-of-use period on the basis of a status of the user.

5. The vehicle control system according to claim 1, wherein the service management device acquires information related to a person who relates to a schedule of the user, and includes the acquired information related to the person who relates to the schedule of the user in the reference information.

6. The vehicle control system according to claim 1, wherein the service management device requires the user to agree that the predetermined service will be provided in the out-of-use period, and performs processing to start the predetermined service when approved by the user.

7. The vehicle control system according to claim 1, wherein the service management device estimates a plurality of out-of-use period candidates having different lengths, and performs processing to provide the predetermined service that is providable in the respective out-of-use period candidates to the user among some or all of the estimated out-of-use period candidates.

8. A vehicle control device comprising:
an acquisition part configured to estimate an out-of-use period in which a user does not use an automated driving vehicle on the basis of reference information including a usage schedule of the automated driving vehicle by the user, and acquire information related to a predetermined service provided in a state in which the user does not use the automated driving vehicle in the estimated out-of-use period; and
a controller configured to generate an action plan of the automated driving vehicle in the out-of-use period on the basis of the information acquired by the acquisition part.

9. A vehicle control method executed by one or more computers, the method comprising:
estimating an out-of-use period in which a user does not use an automated driving vehicle on the basis of reference information including a usage schedule of the automated driving vehicle by the user, and managing a predetermined service provided in a state in which the user does not use the automated driving vehicle in the estimated out-of-use period; and
generating an action plan of the automated driving vehicle in the out-of-use period according to the predetermined service.
